(19) United States
(12) Patent Application Publication
(10) Pub. No.: US 2025/0087399 A1
(43) Pub. Date: Mar. 13, 2025

(54) MAGNETIC PISTON SYSTEM

(71) Applicant: JEROME LOACH, Richmond, VA (US)

(72) Inventor: JEROME LOACH, Richmond, VA (US)

(21) Appl. No.: 18/244,124

(22) Filed: Sep. 8, 2023

(51) Int. Cl. H01F 7/20

(52) U.S. Cl. CPC H01F 7/20

(57) ABSTRACT

The present invention relates to a magnetic piston system that includes: an electromagnetic cap; a magnetized piston; and a cylinder which receives the piston and enables free movement of a piston through the cylinder. The cap initiates the movement of the piston and continuously emits opposing charges to force continued movement of the piston.

### CROSS REFERENCE TO RELATED APPLICATION

This application is a continuation in part of U.S. patent application Ser. No. 17/332,120 filed on May 27, 2021.

### FIELD OF INVENTION

The present invention relates to a magnetic piston system that uses an electromagnetically charged piston for power generation.

### BACKGROUND

Mechanical power generation is a common concept that is applied in various applications. One particular application relates to combustible engines that include at least one piston within a cylinder to engaged with a crankshaft. This particular system is used in various applications but is very common in automobiles and other vehicles. The combustion engine is traditionally powered through petroleum, where petroleum is ignited to force movement of the piston within the cylinder that rotates the crankshaft. A rod extends from the piston and provides the means to support the travel of the piston through the cylinder. This conventional means has been under scrutiny with recent technology to provide energy efficient alternatives. The combustion engine is being replaced with electric or battery powered systems and/or hybrid systems which use electric and petroleum for power. The present invention provides yet another alternative where uses an electromagnetic piston within a cylinder powered with electricity and magnetism.

### BRIEF DESCRIPTION OF DRAWINGS

FIG. 1 depicts an electromagnetic piston system according to the present invention.

FIG. 2 depicts a cylinder and piston without the igniting electromagnetic disk.

### DETAILED DESCRIPTION

The present invention relates to a magnetic piston system. The system, according to the present invention, includes a magnetized piston that is mounted on a piston rod connected to a conventional crankshaft. The magnetized piston travels through a cylinder, where adequate spacing is provided to reduce friction. The piston movement is initiated by an electromagnetic head that is mounted on the top of the piston cylinder. Once this electromagnetic head is charged, it initiates movement of the piston through the cylinder. The piston is charged with north and south polarity, so the magnetized piston moves through the cylinder due to the force of magnetism and opposing polarity.

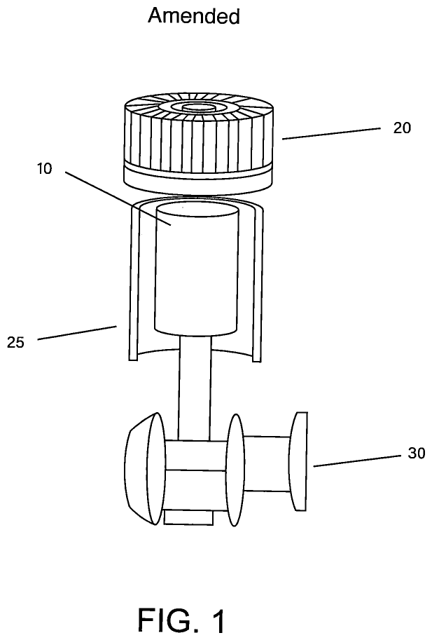

FIG. 1 depicts a system for a magnetic piston system according to the present invention. This system includes an electromagnetic head 20 on top of a Cylinder 25, where the Cylinder 25 may be made of non-magnetic material or less conductive material. The cylinder 25 may include holes to reduce compression and friction. . . . Preferably the piston does not create any compression within the cylinder 25. CV axle grease or other lubrication may be within the cylinder 25 to minimize friction or abrasion . . .

DC or AC power may be used to power an electromagnet cap 20, where a control board, not shown, enables activation. Piston 10 is preferably filled with magnets with opposing polarities such as a plated magnetic piston. The piston 10 may include stacked plates within the piston 10, or a single magnet may be possible. The interior of Cylinder 25 is shown wherein there is some spacing between the piston 10 and the inner cylinder wall. This spacing allows for the free movement of the Piston 10 through the Cylinder 25. A Piston Rod 15 extends from Piston 10 and is attached to a Crankshaft 30 as shown in FIG. 1.

In one exemplary use, the Piston 10 may operate an one piston motor motor and the control box initiates the firing the piston by the charging of the head 20. Either an AC OR DC battery source may be used to start the motor. The electromagnetic cap 20 is controlled by the control box. Magnetic cap bottom with crankshaft. Alternator connected to capacitor. Control box connected magnetic head to release energy to head, electricmagetic. Not perpuatual motion magnetism to electrical power. Magnet fires the nc

The electromagnetic cap 20 is electronically controlled through initiating movement of the Piston 10 through an initial charge of the cap 20. This initial charge starts the movement of the Piston 10 through the Cylinder 25.

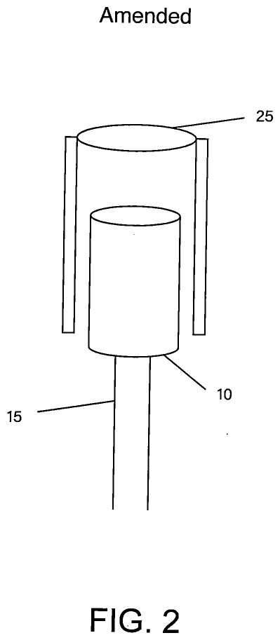

Another view of the Cylinder 25 and Piston 10 is shown in FIG. 2. In this figure, the piston 10 moves through Cylinder 25 and includes pulsation of the charges to allow for movement of the Piston 10 by the electromagnetic head 20.

Powered through a series of capacitors such as a square box battery shape capacitor bank between the control box (ECU) and electromagnetic head 20. An ECU assembly mounts in engine away from the cylinder wall and controls all cylinders. The piston may move through a one third stroke and include a M52 grade magnet. Opposing charges between the head 20 and piston 10 creates a piston pull force and a head push force. Some spacing is allowed between piston and cylinder wall, the piston maintains a tight fit with conventional piston tolerances.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A magnetic piston system comprising:
an electromagnetic cap;
a magnetized piston; and
a cylinder which receives the piston and enables free movement of a piston through the cylinder, wherein the electromagnetic cap fits on top of the piston and ignites an opposing charge to initiate movement of piston and continuously emits opposing charges to sustain piston movement.

2. The magnetic piston system according to claim 1, where the magnetic piston includes a plated magnetic arrangement.
